(19) United States
(12) Patent Application Publication
(10) Pub. No.: US 2013/0201902 A1
(43) Pub. Date: Aug. 8, 2013

(54) RADIO BASE STATION APPARATUS AND RESOURCE ALLOCATION METHOD

(71) Applicants: Satoshi Nagata, Chiyoda-ku (JP); Yuan Yan, Chiyoda-ku (JP); Anxin Li, Chiyoda-ku (JP)

(72) Inventors: Satoshi Nagata, Chiyoda-ku (JP); Yuan Yan, Chiyoda-ku (JP); Anxin Li, Chiyoda-ku (JP)

(73) Assignee: NTT DOCOMO, INC., Tokyo (JP)

(21) Appl. No.: 13/816,942

(22) PCT Filed: Aug. 11, 2011
(86) PCT No.: PCT/JP2011/068396

§ 371 Date: Apr. 22, 2013

(30) Foreign Application Priority Data
Aug. 16, 2010 (JP) 2010-181909

(51) Int. Cl. H04W 72/04

(52) U.S. Cl. CPC H04W 72/04
USPC 370/315

(57) ABSTRACT

The present invention provides a radio base station apparatus and a resource allocation method that can improve the inequality of the amount of radio resources to allocate to UEs under relay nodes and improve the cell edge user throughput performance. The radio base station apparatus according to the present invention has a frequency bandwidth control section (113) that controls the frequency bandwidth for each radio relay station apparatus based on the quality of the backhaul links between the radio base station apparatus and a plurality of radio relay station apparatuses, and a transmission section that transmits downlink signals to the plurality of radio relay station apparatuses over the frequency bandwidth controlled by the frequency bandwidth control section (113).

### TECHNICAL FIELD

The present invention relates to a radio base station apparatus and a resource allocation method to utilize a relay transmission technique in an LTE-A (Long Term Evolution-Advanced) system.

### BACKGROUND ART

In 3GPP (3rd Generation Partnership Project), the standardization of LTE-Advanced (LTE-A) is in progress, as a fourth-generation mobile communication system to realize communication of further increased speed and increased volume from LTE (Long Term Evolution), which is an enhanced standard of the third-generation mobile communication system. In addition to realization of communication of increased speed and increased volume, for LTE-A, increase of the throughput of cell-edge users is an important object, and, as a means for this, a relay technique to relay radio transmission between a radio base station apparatus and mobile terminal apparatuses is under study. By using relay, in places where it is difficult to secure a wired backhaul link, efficient expansion of coverage is anticipated.

Relay techniques include layer 1 relay, layer 2 relay, and layer 3 relay. Layer 1 relay is a relay technique called “booster” or “repeater,” and is an AF (Amplifier and Forward) type relay technique to amplify the power of a downlink received RF signal from a radio base station apparatus and outputs that downlink received RF signal to a mobile terminal apparatus. An uplink received RF signal from the mobile terminal apparatus is also subjected to power amplification and transmitted to the radio base station apparatus. Layer 2 relay is a DF (Decode and Forward) type relay technique to demodulate/decode a downlink received RF signal from a radio base station apparatus, and, after that, perform coding/modulation again, and transmit the result to a mobile terminal apparatus. Layer 3 relay is a relay technique to decode a downlink received RF signal from a radio base station apparatus and, after that, perform demodulation/decoding processes, and, in addition, reconstruct the user data and perform the process for performing user data transmission by radio again (concealment, user data division/coupling processes, and so on), and, after the coding/modulation, transmit the result to a mobile terminal apparatus. Presently, in 3GPP, standardization is in progress with respect to the layer 3 relay technique, from the perspectives of improvement of reception performance by noise cancellation, discussion of the specifications of the standard and feasibility of implementation.

FIG. 1 is a diagram showing an overview of a radio relay technique by layer 3 relay. A radio relay station apparatus (RN) of layer 3 relay performs user data reconstruction, modulation/demodulation, and coding/decoding processes, and, in addition, has a feature of having a unique cell ID (PCI: Physical Cell ID) that is different from that of a radio base station apparatus (eNB). By this means, a mobile terminal apparatus (UE) identifies cell B provided by the radio relay station apparatus as a different cell from cell A provided by the radio base station apparatus. Also, physical layer control signals such as CQI (Channel Quality Indicator), HARQ (Hybrid Automatic Repeat reQuest) and so on end in the radio relay station apparatus, so that, seen from the mobile terminal apparatus, the radio relay station apparatus is identified as a radio base station apparatus. Consequently, a mobile terminal apparatus having LTE functions alone can be connected to the radio relay station apparatus.

Also, the backhaul link (Un) between the radio base station apparatus and the radio relay station apparatus and the access link (Uu) between the radio relay station apparatus and the mobile terminal apparatus may be operated at different frequencies or at the same frequency, and, in the latter case, when the transmitting/receiving processes are performed at the same time in the radio relay station apparatus, unless sufficient isolation can be secured in the transmitting/receiving circuits, a transmission signal goes to the receiver of the radio relay station apparatus and causes interference. Consequently, as shown in FIG. 2, upon operation at the same frequency (f1), radio resources (eNB transmission and relay transmission) for the backhaul link and the access link are time-division multiplexed (TDM: Time Division Multiplexing), and it is necessary to control the radio relay station apparatus not to perform transmission and reception at the same time (non-patent literature 1). Consequently, for example, on the downlink, the radio relay station apparatus is unable to transmit a downlink signal to the mobile terminal apparatus while receiving a downlink signal from the radio base station apparatus.

### CITATION LIST

### Non-Patent Literature

Non-Patent Literature 1: 3GPP, TR 36.814

### SUMMARY OF THE INVENTION

### Technical Problem

However, as shown in FIG. 3, when a plurality of radio relay station apparatuses (relay nodes: RNs) are provided, the amount of interference against mobile terminal apparatuses increases. For example, in FIG. 3, at the relay UE of RN #1 (the UE under RN #1), the transmission signal from RN #2 becomes interference, and, at the relay UE of RN #2 (the UE under RN #2), the transmission signal from RN #1 becomes interference. In this way, by providing RNs, compared to the case where a radio base station apparatus (macro eNB) alone is provided, the amount of interference to give to other cells by transmitted and received signals from the RNs increases.

The present invention has been made in view of the above problems, and it is therefore an object of the present invention to provide a radio relay station apparatus and a mobile terminal apparatus which can improve the inequality of the amount of resources to allocate to UEs under relay nodes and improve the cell edge user throughput performance.

### Solution to Problem

The radio base station apparatus of the present invention has: a frequency bandwidth control section that controls a frequency bandwidth for each radio relay station apparatus based on quality of the backhaul links between the radio base station apparatus and a plurality of radio base station apparatuses; and a transmission section that transmits downlink signals to the plurality of radio relay station apparatuses over the frequency bandwidth controlled by the frequency bandwidth control section.

The resource allocation method of the present invention includes the steps of: based on quality of backhaul links between a radio base station apparatus and a plurality of radio relay station apparatuses, controlling a frequency bandwidth for each radio relay station apparatus; and transmitting downlink signals to the plurality of radio relay station apparatuses over the controlled frequency bandwidth.

### Technical Advantages of the Invention

With the resource allocation method of the present invention, the frequency bandwidth for each radio relay station apparatus is controlled based on the quality of backhaul links between a radio base station apparatus and a plurality of radio relay station apparatuses, and downlink signals are transmitted to the plurality of radio relay station apparatuses over the controlled frequency bandwidth, so that, even when a radio relay station apparatus is provided, it is possible to reduce the amount of interference from the radio relay station apparatus and improve throughput.

### BRIEF DESCRIPTION OF THE DRAWINGS

FIG. 1 is a diagram for explaining a relay transmission technique;

FIG. 2 is a diagram for explaining backhaul link and access link radio resources;

FIG. 3 is a diagram for explaining a radio relay method;

FIG. 4A and FIG. 4B are each a diagram for explaining a subframe configuration of a backhaul link;

FIG. 5 is a diagram for explaining a resource allocation method according to an embodiment of the present invention;

FIG. 6A and FIG. 6B are each a diagram for explaining effects of a resource allocation method according to an embodiment of the present invention;

FIG. 7 is a block diagram showing a schematic configuration of a radio base station apparatus according to an embodiment of the present invention; and

FIG. 8 is a block diagram showing a schematic configuration of a radio base station apparatus according to an embodiment of the present invention.

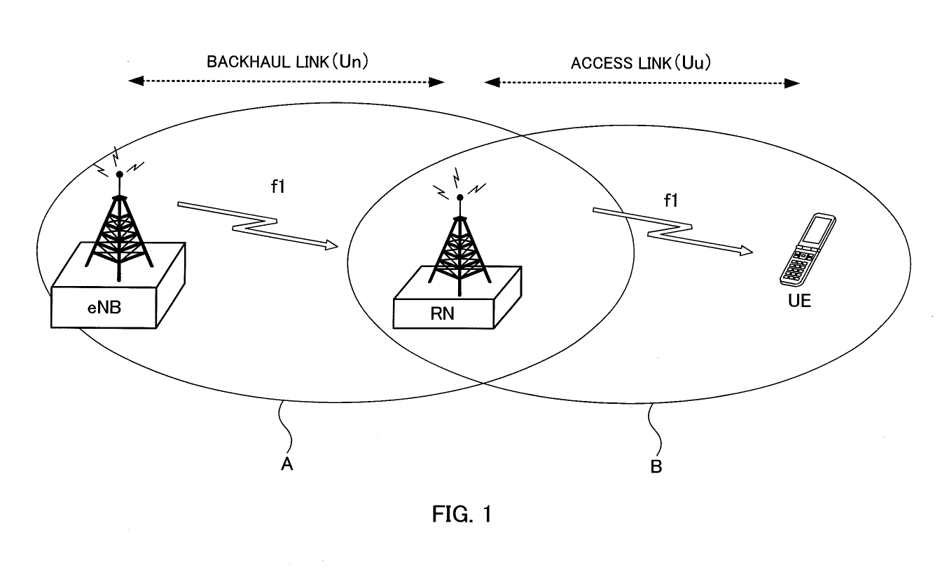

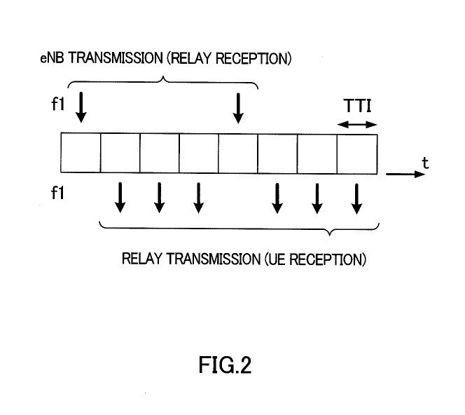

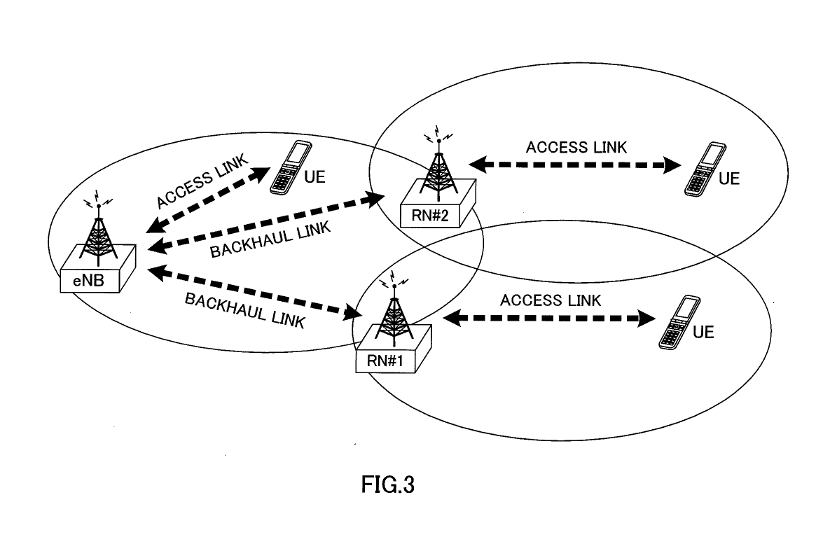

### DESCRIPTION OF EMBODIMENTS

Now, embodiments of the present invention will be described below in detail with reference to the accompanying drawings. Hereinafter an “eNB” represents a radio base station apparatus, a “macro UE” represents a mobile terminal apparatus under an eNB, a “relay UE” represents a mobile terminal apparatus under a radio relay station apparatus, and an “RN” represents a radio relay station apparatus.

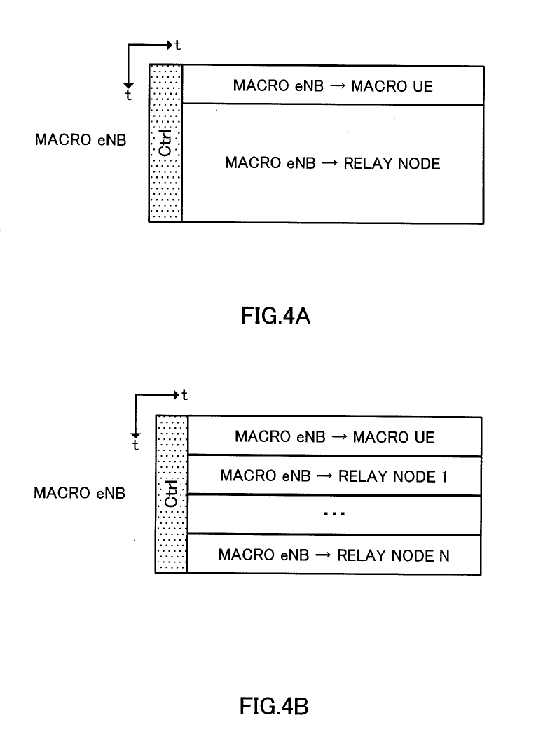

With a radio relay technique by layer 3 relay, the downlink subframe configuration is as shown in FIG. 4A. In FIG. 4A, there is a backhaul (MBSFN: MBMS over a Single Frequency Network) subframe for providing a service of distributing broadcast-type content to many users (MBMS: Multimedia Broadcast Multicast Service) simultaneously over a single-frequency network.

On the backhaul link from a macro eNB (radio base station apparatus) to relay nodes (radio relay station apparatuses), data and control signals are transmitted in backhaul subframes. In this case, the data includes data from the macro eNB to macro UEs (mobile terminal apparatuses under an eNB) and data from the macro eNB to the relay nodes.

For the most simple resource allocation in backhaul subframes, allocating all the resources only to the relay nodes, without dividing the resources, is possible. However, transmission data for a relay node is proportional to the number of relay UEs (the number of UEs under the radio relay station apparatus), and, in particular, when the number of relay UEs is small, it is not necessary to allocate all the resource to the relay node. Then, the throughput of the whole system (cell) is anticipated to improve by allocating part of the resource to the macro UEs.

Consequently, in radio resource allocation in backhaul link subframes, as shown in FIG. 4A, radio resources are distributed between macro UEs (UEs that are directly connected to the macro eNodeB) and relay nodes (radio relay station apparatuses).

Here, the resource distribution between the macro UEs and the relay nodes is preferably determined in accordance with following formula 1. In this case, the frequency bandwidth in backhaul subframes is controlled based on the number of backhaul subframes, the number of UEs, and the spectral efficiency of radio links. That is to say, the ratio (X) of resource blocks to allocate to the relay nodes in backhaul subframes is calculated according to following formula 1:

X=(the spectral efficiency of links from the eNB to macro UEs×the number of relay UEs)/{(the spectral efficiency of links from the eNB to macro UEs×the number of relay UEs)+(the spectral efficiency of links from the eNB to RNs×the number of macro UEs)}×(the total number of subframes per frame/the number of backhaul subframes per frame) (Formula 1)

where the spectral efficiency means the spectral efficiency (SE) of the MCS (Modulation and Coding Scheme) mode applied to the (macro eNB→macro UEs)/(macro eNB→relay nodes) links.

In this case, when the SE (quality) of the eNB→RNs links is good compared to the eNB→macro UEs links, it is preferable to control the frequency bandwidth to reduce the RBs (Resource Blocks) to allocate to the RNs.

Also, the resource distribution between the macro UEs and the relay nodes is preferably determined in accordance with following formula 2: That is to say, the ratio (X) of resource blocks to allocate to the relay nodes in backhaul subframes may be calculated according to following formula 2:

X={(the number of relay UEs)/(the number of relay UEs+the number of macro UEs)}×(the total number of subframes per frame/the number of backhaul subframes per frame) (Formula 2)

Also, as for the radio resource allocation in backhaul link subframes, as shown in FIG. 4B, radio resources are distributed between a plurality of relay nodes (relay node 1 to relay node N). For such resource distribution between a plurality of relay nodes, the following three modes are possible.

### (Mode 1)

According to the present mode, the frequency bandwidth for each individual relay node is controlled based on the number of UEs connected to the relay node and the quality of the backhaul link (for example, the spectral efficiency: SE). For example, radio resource allocation between relay nodes on the backhaul link is determined according to following formula 3. Note that SE can be calculated using received quality information (CQI: Channel Quality Indicator) that is reported from the relay nodes (for example, can be calculated using the CQI of the whole frequency band).

The number of RBs (resource blocks) for RN 1: the number of RBs for RN 2=the number of relay UEs of RN 1/the SE of the backhaul link of RN 1: the number of relay UEs of RN 2/the SE of the backhaul link of RN 2 (Formula 3)

For example, as shown in FIG. 5, when the number of relay UEs of relay node 1 is two, the number of relay UEs of relay node 2 is four, the SE of relay node 1 is six (64QAM) and the SE of relay node 2 is four (16QAM), 2/6:4/4=1:3 holds from formula 3. Consequently, radio resources are allocated such that 25% of the backhaul resources is used for relay node 1 and 75% of the backhaul resources is used for relay node 2.

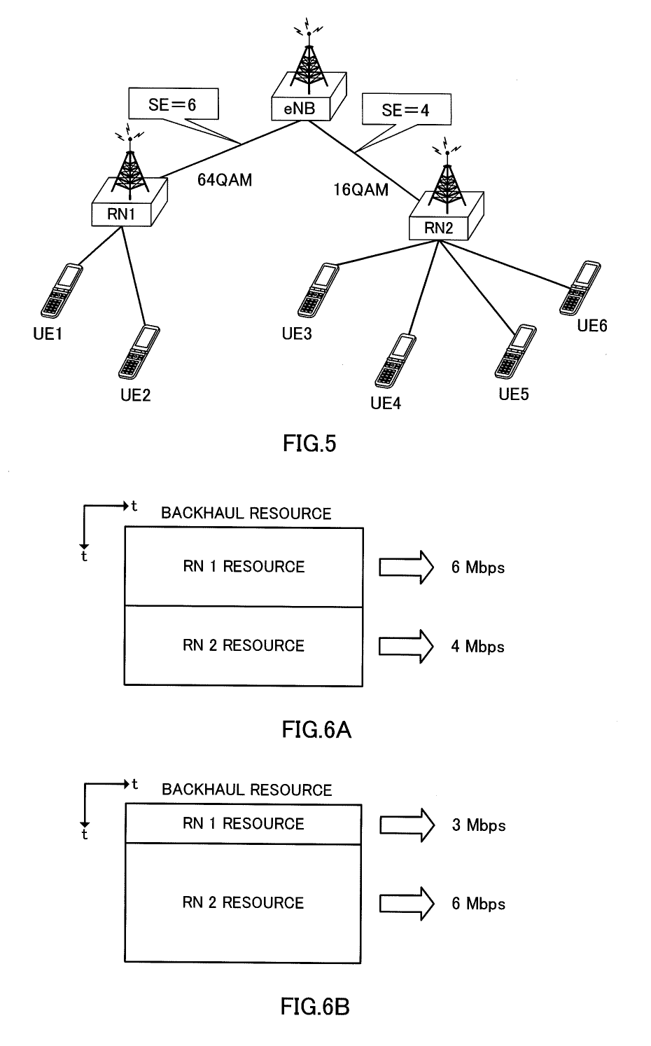

As shown in FIG. 6A, when resources for a relay node (RN 1) and resources for another relay node (RN 2) are allocated alike, one relay node (RN 1) (to which two UEs are connected) has backhaul link quality of 6 Mbps, and the other relay node (RN 2) (to which four UEs are connected) has backhaul link quality of 4 Mbps. In this case, the relay node where the number of connecting UEs is two has higher backhaul link quality, and the relay node where the number of connecting UEs is four has lower backhaul link quality. In this way, when the quality of a backhaul link having a greater number of connecting UEs is low, the cell edge user throughput performance becomes poor. Meanwhile, according to this mode, as shown in FIG. 6B, one relay node (RN 1) (to which two UEs are connected) has backhaul link quality of 3 Mbps, and the other relay node (RN 2) (to which four UEs are connected) has backhaul link quality of 6 Mbps. By this means, the average throughput for each relay UE becomes approximately the same between the backhaul link of relay node 1 and the backhaul link of relay node 2 (which is improvement of cell edge throughput performance). In particular, when the amount of radio resources to allocate to the backhaul links is small, it is possible to improve the inequality of the amount of radio resources to allocate to UEs and improve the cell edge user throughput performance.

### (Mode 2)

According to the present mode, the frequency bandwidth for each individual relay node is controlled based on the number of relay nodes (the number of relay nodes per cell) under the radio base station apparatus, the number of UEs connected to the relay node, the quality of the backhaul link (for example, the spectral efficiency: SE), and the number of backhaul link RBs. For example, radio resource allocation between relay nodes on the backhaul link is determined according to following formula 4:

$$The number of RBs to allocate to the backhaul link of the i \text{-} th relay node = M \cdot \frac{{K}_{i} / {SE}_{i}}{{\sum }_{n = 1}^{N} ( {K}_{n} / {SE}_{n} )} \qquad ( Formula 4 )$$

where N is the number of relay nodes per cell, Kᵢ is the number of UEs connected to the i-th relay node, SEᵢ is the SE of the backhaul link of the i-th relay node, and M is the number of backhaul link RBs.

The radio resource allocation using above formula 4 can also be applied to each individual backhaul subframe and is also applicable between a plurality of backhaul subframes. Note that SEᵢ can be calculated using received quality information (CQI) that is reported from the relay nodes, and so on (for example, can be calculated using the CQI of the whole frequency band). According to this mode, radio resource allocation can be determined using only the number of UEs connected to the relay nodes, the number of relay nodes per cell, and the quality of the backhaul link.

### (Mode 3)

According to the present mode, the frequency bandwidth for each individual relay node controlled based on the amount of data transmission to the UEs connected to the relay node and the quality of the backhaul link (for example, the spectral efficiency: SE). For example, radio resource allocation between relay nodes on the backhaul link is determined based on following formula 5:

the number of RBs for RN 1: the number of RBs for RN 2=the amount of data transmission for relay UEs of RN 1/the SE of the backhaul link of RN 1: the amount of data transmission for relay UEs of RN 2/the SE of the backhaul link of RN 2 (Formula 5)

Note that the SE can be calculated using received quality information (CQI) that is reported from the relay nodes, and so on (for example, can be calculated using the CQI of the whole frequency band). According to this mode, radio resource allocation is determined using the amount of data to transmit to the UEs connected to the relay nodes, the number of relay nodes per cell, and the backhaul link quality, so that, in comparison with mode 2, although the amount of data to transmit to the UEs connected to the relay nodes has to be taken into account, more optimal radio resource distribution can be realized based on the amount of data to actually transmit.

In this way, with the resource allocation method according to the present invention, radio resources are first distributed to macro UEs and relay nodes (allocation of the frequency bandwidth for each relay node), and, after that, radio resources are distributed between a plurality of relay nodes by the methods shown in the above modes. Note that it is preferable that the resources (the number of subframes) to allocate to the relay nodes are determined semi-statically by the macro eNodeB.

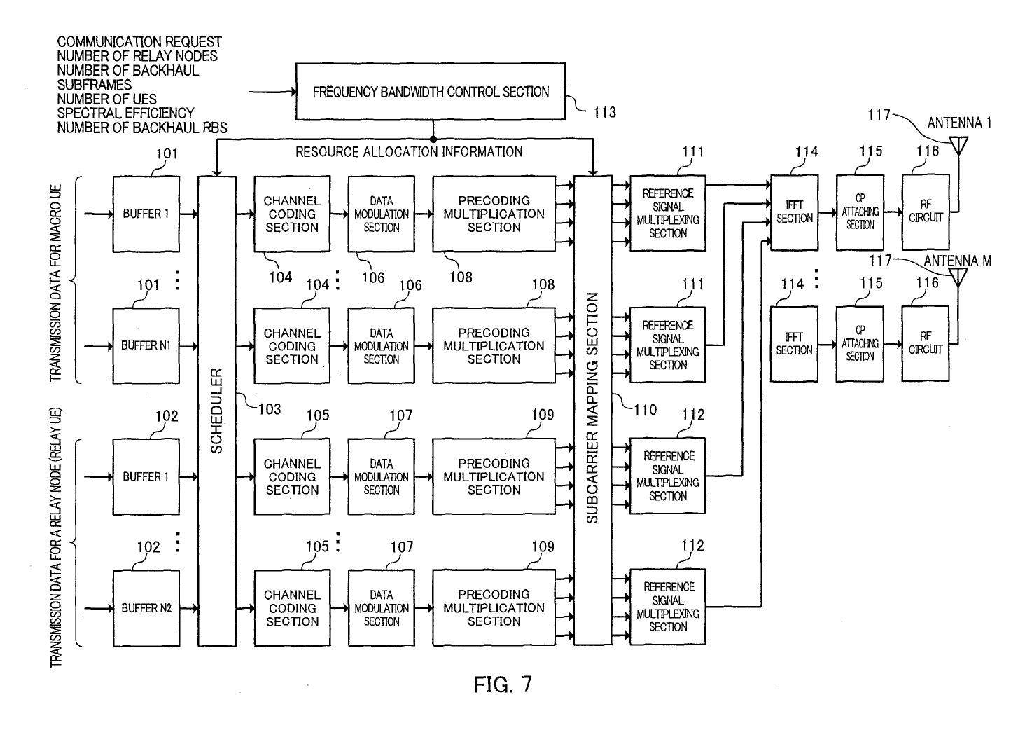

FIG. 7 is a block diagram showing a schematic configuration of a radio base station apparatus according to an embodiment of the present invention. The radio base station apparatus shown in FIG. 7 has a transmission section and a receiving section. The transmission section side alone will be described here.

The radio base station apparatus shown in FIG. 7 is primarily formed with transmission data buffers (1 to N1) 101 for macro UEs, transmission data buffers (1 to N2) 102 for relay nodes, a scheduler 103, a channel coding section 104 for transmission data for macro UEs, a channel coding section 105 for transmission data for relay nodes, a data modulation section 106 for transmission data for macro UEs, a data modulation section 107 for transmission data for relay nodes, a precoding multiplication section 108 for transmission data for macro UEs, a precoding multiplication section 109 for transmission data for relay nodes, a subcarrier mapping section 110, a reference signal multiplexing section 111 for transmission data for macro UEs, a reference signal multiplexing section 112 for transmission data for relay nodes, a frequency bandwidth control section 113, an IFFT (Inverse Fast Fourier Transform) section 114, a CP (Cyclic Prefix) attaching section 115, an RF circuit 116, and antennas (1 to M) 117.

The transmission data buffers (1 to N1) 101 for macro UEs store data to transmit to macro UEs. The transmission data buffers (1 to N2) 102 for relay node store data to transmit to relay nodes.

The scheduler 103 schedules the data to transmit to macro UEs, stored in the transmission data buffers (1 to N1) 101 for macro UEs, and the data to transmit to relay nodes, stored in the transmission data buffers (1 to N2) 102 for relay nodes. The scheduler 103 schedules the data to transmit to macro UEs and the data to transmit to relay nodes over the frequency bandwidth controlled by the frequency bandwidth control section 113. The control in the frequency bandwidth control section 113 will be described later.

The channel coding section 104 for transmission data for macro UEs performs channel coding of transmission data for macro UEs. The channel coding section 104 outputs the data after the channel coding to the data modulation section 106. The channel coding section 105 for transmission data for relay nodes performs channel coding of transmission data for relay nodes. The channel coding section 105 outputs the data after the channel coding to the data modulation section 107.

The data modulation section 106 for transmission data for macro UEs modulates the data after the channel coding. The data modulation section 106 outputs the data after the data modulation to the precoding multiplication section 108. The data modulation section 107 for transmission data for relay nodes modulates the data after the channel coding. The data modulation section 107 outputs the data after the data modulation to the precoding multiplication section 109.

The precoding multiplication section 108 for transmission data for macro UEs multiplies the data after the data modulation by a precoding weight. The precoding multiplication section 108 outputs the data after the precoding weight multiplication to the subcarrier mapping section 110. The precoding multiplication section 109 for transmission data for relay nodes multiplies the data after the data modulation by a precoding weight. The precoding multiplication section 109 outputs the data after the precoding weight multiplication to the subcarrier mapping section 110.

The subcarrier mapping section 110 maps a frequency domain signal to subcarriers based on resource allocation information. The subcarrier mapping section 110 outputs the mapped data for macro UEs to the reference signal multiplexing section 111 and also outputs the mapped data for relay nodes to the reference signal multiplexing section 112.

The reference signal multiplexing section 111 multiplexes a reference signal upon the data for macro UEs. The reference signal multiplexing section 111 outputs the data on which a reference signal is multiplexed, to the IFFT section 114. The reference signal multiplexing section 112 multiplexes a reference signal upon the data for relay nodes. The reference signal multiplexing section 112 outputs the data on which a reference signal is multiplexed, to the IFFT section 114.

The IFFT section 114 converts the signal on which a reference signal is multiplexed, into a time domain signal, by performing an IFFT. The IFFT section 114 outputs the signal after the IFFT to the CP attaching section 115. The CP attaching section 115 attaches CPs to the signal after the IFFT. The CP attaching section 115 outputs the signal to which CPs are attached, to the RF circuit 116. The RF circuit 116 applies predetermined RF processing to the signal to which CPs are attached, and outputs the result to the macro UEs and/or relay nodes, from the antenna (1 to M) 117. According to this configuration, downlink signals are transmitted to a plurality of relay nodes over a frequency bandwidth controlled by the frequency bandwidth control section 113, which will be described later.

The frequency bandwidth control section 113 controls the frequency bandwidth for macro UEs/relay nodes based on the number of backhaul subframes, the number of subscribers (macro UEs, relay UEs and so on), and the spectral efficiency of radio links (macro eNB→macro UEs and macro eNB→relay nodes). Also, the frequency bandwidth control section 113 controls the frequency bandwidth for each individual relay node based on the quality (spectral efficiency) of the radio link (backhaul link). In this case, the frequency bandwidth control section 113 may control the frequency bandwidth for each individual relay node based on the number of UEs connected to the relay node and the quality of the backhaul link (mode 1), may control the frequency bandwidth for each individual relay node based on the number of relay nodes per cell, the number of UEs connected to the relay node, the quality of the backhaul link, and the number of backhaul link resource blocks (mode 2), or may control the frequency bandwidth for each individual relay node based on the amount of data transmission to the UEs connected to the relay node and the quality of the backhaul link (mode 3). The frequency bandwidth control section 113 outputs information about the frequency bandwidth (for example, the RBs to allocate to RNs, resource distribution information between relay nodes and so on) to the scheduler 103 and the subcarrier mapping section 110, as resource allocation information.

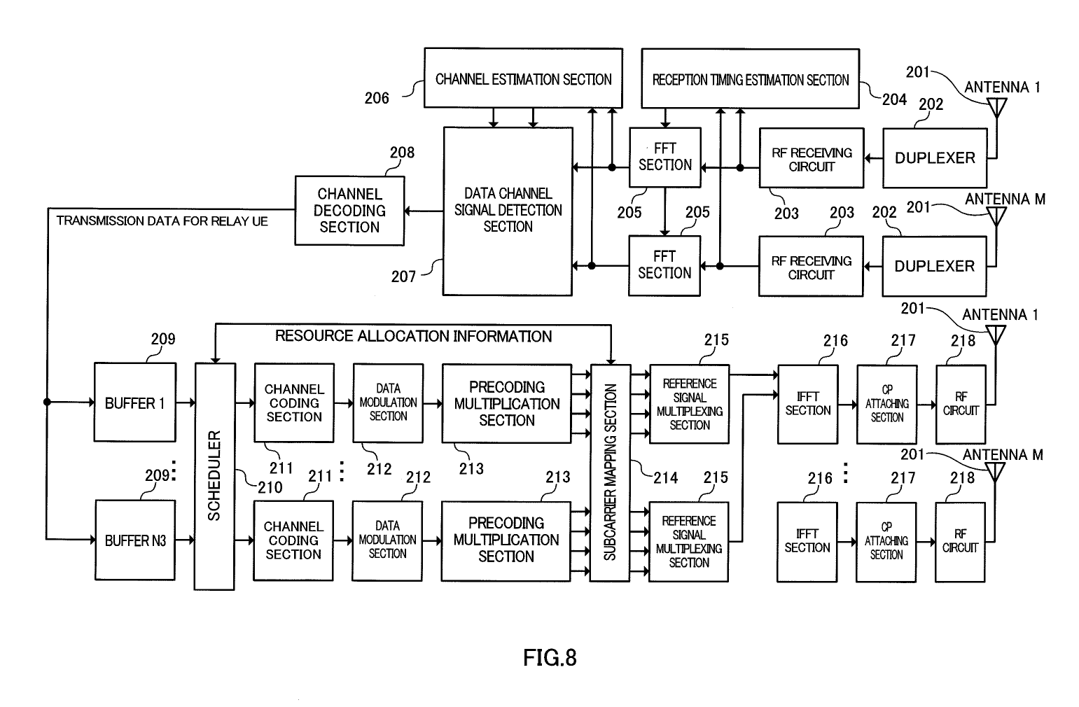

FIG. 8 is a block diagram showing a schematic configuration of a radio base station apparatus (relay node) according to an embodiment of the present invention. The radio relay station apparatus shown in FIG. 8 has a transmission section and a receiving section.

The receiving section of the radio relay station apparatus shown in FIG. 8 has antennas (1 to M) 201, a duplexer 202, an RF receiving circuit 203, a reception timing estimation section 204, an FFT (Fast Fourier Transform) section 205, a channel estimation section 206, a data channel signal detection section 207, and a channel decoding section 208.

The RF receiving circuit 203 performs RF receiving processing of a downlink signal from the macro eNB. The RF receiving circuit 203 outputs the signal after the RF receiving processing to the FFT section 205 and the reception timing estimation section 204. The reception timing estimation section 204 estimates the receiving timing using the signal after the RF receiving processing, and outputs the estimated value to the FFT section 205.

The FFT section 205 performs FFT process on the received signal using the estimated value of the receiving timing. The FFT section 205 outputs the signal after the FFT to the data channel signal detection section 207. The reference signal after the FFT is transmitted to the channel estimation section 206. The channel estimation section 206 performs channel estimation using the reference signal, and outputs the channel estimation value to the data channel signal detection section 207.

The data channel signal detection section 207 detects the data channel signal using the channel estimation value. The data channel signal detection section 207 outputs the data channel signal to the channel decoding section 208. The channel decoding section 208 decodes the data channel signal and outputs the decoded signal to the buffers (1 to N3) 209. In this way, the data to transmit from relay node to relay UE is stored in the buffers 209.

The transmission section of the radio relay station apparatus shown in FIG. 8 is primarily formed with buffers (1 to N3) 209, a scheduler 210, a channel coding section 211, a data modulation section 212, a precoding multiplication section 213, a subcarrier mapping section 214, a reference signal multiplexing section 215, an IFFT section 216, a CP attaching section 217, an RF circuit 218, and antennas (1 to M) 201.

The buffers (1 to N1) 209 store the data to transmit to relay UEs. The scheduler 210 schedules the data to transmit to relay UE stored in the buffers (1 to N1) 209. The channel coding section 211 performs channel coding of transmission data. The channel coding section 211 outputs the data after the channel coding to the data modulation section 212.

The data modulation section 212 modulates the data after the channel coding. The data modulation section 212 outputs the data after the data modulation to the precoding multiplication section 213. The precoding multiplication section 213 multiplies the data after the data modulation by a precoding weight. The precoding multiplication section 213 outputs the data after the precoding weight multiplication to the subcarrier mapping section 214.

The subcarrier mapping section 214 maps frequency domain signal to subcarriers based on resource allocation information. The subcarrier mapping section 214 outputs the mapped signal to the reference signal multiplexing section 215. The reference signal multiplexing section 215 multiplexes a reference signal upon the data. The reference signal multiplexing section 215 outputs the data on which a reference signal is multiplexed, to the IFFT section 216.

The IFFT section 216 converts the signal on which a reference signal is multiplexed, into a time domain signal, by performing an IFFT. The IFFT section 216 outputs the signal after the IFFT to the CP attaching section 217. The CP attaching section 2173 attaches CPs to the signal after the IFFT. The CP attaching section 217 outputs the signal, to which CPs are attached, to the RF circuit 218. The RF circuit 218 applies predetermined RF processing to the signal, to which CPs are attached, and transmits to the relay UEs, from the antennas (1 to M) 201.

With this configuration, after the frequency bandwidth control section 113 of the macro eNodeB distributes radio resources to macro UEs and relay nodes (allocation of the frequency bandwidth for each relay node), radio resources are distributed between a plurality of relay nodes by the methods shown in the above modes. And downlink signals are transmitted to a plurality of relay nodes over the frequency bandwidth controlled (radio resource distribution). By this means, it is possible to improve the inequality of the amount of radio resources to allocate to UEs under relay nodes and improve the cell edge user throughput performance.

Also, the embodiments disclosed herein are only examples in all respects, and are by no means limited to these embodiments. The scope of the present invention is defined not only by the descriptions of the above embodiments and also is set by the claims, and covers all the modifications and alterations within the meaning and range equivalent to the claims.

### INDUSTRIAL APPLICABILITY

The present invention is suitable for use for a radio base station apparatus and a resource allocation method in an LTE-A system.

The disclosure of Japanese Patent Application No. 2010-181909, filed on Aug. 16, 2010, and abstract, is incorporated herein by reference in its entirety.

1. A radio base station apparatus having backhaul links with a plurality of radio relay station apparatuses, the radio base station apparatus comprising:
a frequency bandwidth control section that controls a frequency bandwidth for each radio relay station apparatus based on quality of the backhaul links; and
a transmission section that transmits downlink signals to the plurality of radio relay station apparatuses over the frequency bandwidth controlled by the frequency bandwidth control section.

2. The radio base station apparatus according to claim 1, wherein the frequency bandwidth control section controls the frequency bandwidth for each radio relay station apparatus based on the number of mobile terminal apparatuses connected to the radio relay station apparatus and quality of a backhaul link.

3. The radio base station apparatus according to claim 1, wherein the frequency bandwidth control section controls the frequency bandwidth for each radio relay station apparatus based on the number of radio relay station apparatuses under the radio base station apparatus, the number of mobile terminal apparatuses connected to the radio relay station apparatus, quality of a backhaul link, and the number of resource blocks of a backhaul link.

4. The radio base station apparatus according to claim 1, wherein the frequency bandwidth control section controls the frequency bandwidth for each radio relay station apparatus based on the amount of data transmission to mobile terminal apparatuses connected to the radio relay station apparatus and quality of a backhaul link.

5. The radio base station apparatus according to claim 1, wherein the frequency bandwidth control section controls the frequency bandwidths in backhaul subframes based on the number of backhaul subframes, the number of mobile terminal apparatuses and spectral efficiency of the backhaul links.

6. The radio base station apparatus according to claim 5, wherein the frequency bandwidth control section calculates a ratio (X) of resource blocks to allocate to a radio relay station apparatus in a backhaul subframe in accordance with following formula 1:
X=(spectral efficiency of links from an eNB to macro UEs×the number of relay UEs)/{(spectral efficiency of links from the eNB to macro UEs×the number of relay UEs)+(spectral efficiency of links from the eNB to RNs×the number of macro UEs)}×(the total number of subframes per frame/the number of backhaul subframes per frame) (Formula 1)
where the eNB represents the radio base station apparatus, the macro UEs represent mobile terminal apparatuses under the eNB, the relay UEs represent mobile terminal apparatuses under the radio relay station apparatus, and the RNs represent the radio relay station apparatuses.

7. A resource allocation method comprising the steps of:
based on quality of backhaul links between a radio base station apparatus and a plurality of radio relay station apparatuses, controlling a frequency bandwidth for each radio relay station apparatus; and
transmitting downlink signals to the plurality of radio relay station apparatuses over a controlled frequency bandwidth.

8. The resource allocation method according to claim 7, wherein the frequency bandwidth for each radio relay station apparatus is controlled based on the number of mobile terminal apparatuses connected to the radio relay station apparatus and quality of a backhaul link.

9. The resource allocation method according to claim 7, wherein the frequency bandwidth for each radio relay station apparatus is controlled based on the number of radio relay station apparatuses under the radio base station apparatus, the number of mobile terminal apparatuses connected to the radio relay station apparatus, quality of a backhaul link, and the number of resource blocks of a backhaul link.

10. The resource allocation method according to claim 7, wherein the frequency bandwidth for each radio relay station apparatus is controlled based on the amount of data transmission to mobile terminal apparatuses connected to the radio relay station apparatus and quality of a backhaul link.

11. The resource allocation method according to claim 7, wherein, after a frequency bandwidth in a backhaul subframe is allocated based on the number of backhaul subframes, the number of mobile terminal apparatuses and spectral efficiency of the radio links, the frequency bandwidth for the radio relay station apparatuses is allocated.

12. The resource allocation method according to claim 11, wherein a ratio (X) of resource blocks to allocate to a radio relay station apparatus in a backhaul subframe is calculated in accordance with following formula 1:
X=(spectral efficiency of links from an eNB to macro UEs×the number of relay UEs)/{(spectral efficiency of links from the eNB to macro UEs×the number of relay UEs)+(spectral efficiency of links from the eNB to RNs×the number of macro UEs)}×(the total number of subframes per frame/the number of backhaul subframes per frame) (Formula 1)
where the eNB represents the radio base station apparatus, the macro UEs represent mobile terminal apparatuses under the eNB, the relay UEs represent mobile terminal apparatuses under the radio relay station apparatus, and the RNs represent the radio relay station apparatuses.

13. The radio base station apparatus according to claim 2, wherein the frequency bandwidth control section controls the frequency bandwidths in backhaul subframes based on the number of backhaul subframes, the number of mobile terminal apparatuses and spectral efficiency of the backhaul links.

14. The radio base station apparatus according to claim 3, wherein the frequency bandwidth control section controls the frequency bandwidths in backhaul subframes based on the number of backhaul subframes, the number of mobile terminal apparatuses and spectral efficiency of the backhaul links.

15. The radio base station apparatus according to claim 4, wherein the frequency bandwidth control section controls the frequency bandwidths in backhaul subframes based on the number of backhaul subframes, the number of mobile terminal apparatuses and spectral efficiency of the backhaul links.

16. The resource allocation method according to claim 8, wherein, after a frequency bandwidth in a backhaul subframe is allocated based on the number of backhaul subframes, the number of mobile terminal apparatuses and spectral efficiency of the radio links, the frequency bandwidth for the radio relay station apparatuses is allocated.

17. The resource allocation method according to claim 9, wherein, after a frequency bandwidth in a backhaul subframe is allocated based on the number of backhaul subframes, the number of mobile terminal apparatuses and spectral efficiency of the radio links, the frequency bandwidth for the radio relay station apparatuses is allocated.

18. The resource allocation method according to claim 10, wherein, after a frequency bandwidth in a backhaul subframe is allocated based on the number of backhaul subframes, the number of mobile terminal apparatuses and spectral efficiency of the radio links, the frequency bandwidth for the radio relay station apparatuses is allocated.
